(19) United States
(12) Patent Application Publication
(10) Pub. No.: US 2002/0008431 A1
(43) Pub. Date: Jan. 24, 2002

(54) Spindle motor

(75) Inventors: Rikuro Obara, Nagano-ken (JP); Hiroshi Yoshikawa, Nagano-ken (JP)

Correspondence Address: ISRAEL GOPSTEIN, Esq., 14301 Layhill Rd., Suite 200C, P.O. Box 9303, Silver Spring, MD, 20916-9303, US

(73) Assignee: MINEBEA KABUSHIKI-KAISHA

(21) Appl. No.: 09/861,677

(22) Filed: May 22, 2001

(30) Foreign Application Priority Data
Jun. 30, 2000 (JP) 2000-197919

(51) Int. Cl. H02K 5/16; H02K 7/08; H02K 11/00

(52) U.S. Cl. 310/90; 310/67 R

(57) ABSTRACT

A spindle motor including a bearing means which is not seized under the high speed rotational operation and with reduced fretting wear. Consequently, the densification of the hard disk drive device can be achieved.

A spindle motor comprising a spindle shaft, a rotor, and a bearing means interposed between the spindle shaft and the rotor, the bearing means includes inner and outer rings and rolling elements interposed therebetween, wherein the inner and outer rings of the bearing means are made of steel, and the rolling elements are made of ceramic.

### BACKGROUND OF THE INVENTION

1. Technical Field

The present invention relates to an improvement of a spindle motor employed in peripheral devices for computers such as the hard disk drive device, the video tape recorder (VTR), and so on.

2. Description of the Prior Art

There are a variety of equipments using a spindle motor. A personal computer is one of these equipments in which a high speed spindle motor is used in the hard disk drive device of compact size comprised in the computer.

The bearing means used for such spindle motor has a size ranged from ID (inner diameter)=4 mm and OD (outer diameter)=8 mm to ID=6 mm and OD=15 mm, such bearing means is related to as a miniature bearing.

The one of such bearing means has a structure including a straight shaft, an inner ring having an inner raceway formed on its outer peripheral surface, an outer ring having an outer raceway formed on its inner peripheral surface, and a plurality of rolling elements or balls interposed between the inner raceway and the outer raceway and retained in their position by a retainer.

The other bearing means of another structure has a spindle shaft of stepped structure in which a reduced diameter portion and a larger diameter portion are provided. The bearing means including the stepped shaft further comprises an outer ring of cylindrical configuration disposed around the spindle shaft, and an inner ring having an inner raceway formed on the outer peripheral surface thereof, the inner ring is fit around the reduced diameter portion of the stepped shaft and secured thereto. A pair of double row outer raceways are formed on an inner peripheral surface of the outer ring. Balls are interposed between the one outer raceway and the inner raceway, and retained in their position by a retainer.

Further, balls are interposed between an inner raceway formed around an outer peripheral surface of the larger diameter portion of the spindle shaft and the other outer raceway, and retained in their position by a retainer.

Recently, a remarkable development or improvement has been achieved in the hard disk drive device on miniaturization and densification. Especially for the hard disk drive device of the size equal to or less than 3.5 inch, the densification is increased rapidly. More recently, the hard disk drive device of the size of 2.5 inch to be incorporated into personal computers of the note book type is also demanded to have substantially the same memory capacity as that of the hard disk drive device of 3.5 inch in spite of its small size. In order to enlarge the memory capacity of the hard disk drive device of the size of 2.5 inch, it is necessary to increase both of the track recording density and the track density. The presently demanded track density is from 10 KTPI to 14 KTPI (TPI: Track Per Inch).

In either hard disk drive device the size of which is 3.5 inch or 2.5 inch, it is necessary to increase the number of revolutions of the magnetic disk or disks to increase the data transfer rate of the hard disk drive device. For example, the hard disk drive device of 3.5 inch requires the number of revolutions from 5400 rpm to 7200 rpm, and in some cases, the number of revolutions over 10000 rpm is required.

However, in the bearing means adapted to be incorporated into such hard disk drive device of small size, localized stresses are generated repeatedly between the balls and the inner and/or outer rings so that the raceway surfaces and the surfaces of the rolling elements are tend to be roughened. Thus, the above mentioned bearing means involves disadvantages such as the increasing of the vibration, the deterioration of the acoustic characteristics (more noises are generated), and the reduction of the lifetime of the bearing means.

In order to prevent the raceway surfaces and the surfaces of the balls from wearing or damaging, the inner and outer rings and the rolling elements are normally formed of high carbon chromium steel (SUJ 2 or the one similar to SUJ 2), and the hardness of the surfaces are increased by the hardening process to HRC 58-64. Provided that corrosion resistance is required, martensitic stainless steel (the one similar to SUS 440 C) may be utilized.

When transporting the spindle motor including a bearing means, the spindle shaft is inhibited in its rotation. When vibrations are caused to be generated under such circumstances, impact loads are applied repeatedly between the balls and the raceways of the inner and/or outer rings. In such situation, the balls and the raceways are metal to metal contact with each other, and no film of grease is formed therebetween.

Thus the rolling elements and the raceways are tend to make micro slips repeatedly and generate localized wearing i.e. the fretting wear. This fretting wear will affect the vibration and the acoustic characteristics.

Although the grease of high viscosity is effective in avoiding such fretting wear, the viscous resistance of such grease will increase the required rotational torque, the demand of the motor, and generated heat energy. Consequently, the grease of high viscosity is not preferred.

As the number of revolutions of the hard disk drive device is increased as mentioned above, the viscosity of the injected grease tends to decrease by the heat generated in the bearing means. This will interfere the formation of the oil film of the grease at the contact region between the balls and the raceway surfaces, and in the worst case, there is a risk for seizure caused by the breakage of the oil film.

While the oil film of the grease is not formed on the contact regions between the rolling elements and the raceway surfaces, localized frictions are caused to be produced thereon, and the surfaces of the regions are damaged or roughened.

When the surfaces are roughened, the vibration is increased, the acoustic characteristics are deteriorated, and the lifetime of the bearing means is shortened.

Among the above mentioned drawbacks, the generation of the vibration is especially undesirable, since the vibration affects the run-out of the spindle motor and impairs the precision of the placement of the magnetic head of the high density hard disk drive device.

Accordingly, the object of the present invention is to overcome the above mentioned problems. In accordance with the present invention, a spindle motor including a bearing means which will not seize under the high speed rotational operation and fretting wear will be reduced. Consequently, densification of the hard disk drive device can be achieved.

### SUMMARY OF THE INVENTION

These and other objects are achieved by a spindle motor including a bearing means of the present invention.

In a spindle motor in accordance to the first aspect of the present invention, the spindle motor comprising a spindle shaft, a rotor, and a bearing means interposed between the spindle shaft and the rotor, the bearing means includes an inner and outer rings and rolling elements interposed therebetween, characterized in that the inner and outer rings of the bearing means are made of steel, and the rolling elements are made of ceramic.

The spindle motor in accordance with the second aspect of the present invention has a structure that the spindle shaft is a straight shaft, and the bearing means is the ball bearing.

The spindle motor in accordance with the third aspect of the present invention has a structure that the spindle shaft of is a stepped shaft including a larger diameter portion and a reduced diameter portion, the outer ring is a cylindrical one surrounding the stepped shaft, the inner ring has an inner raceway on its outer peripheral surface is fit around the reduced diameter portion of the spindle shaft and secured thereto, the bearing means further includes rolling elements interposed between the inner raceway and an outer raceway formed on the inner periphery of the outer ring, and rolling elements interposed between an inner raceway formed directly on the larger diameter portion of the spindle shaft and another outer raceway formed on the inner periphery of the outer ring.

The spindle motors of the above mentioned structure are substantially the same as those of the spindle motor including a bearing means of the prior art in that the rotor is rotated by being energized.

### BRIEF DESCRIPTION OF THE DRAWINGS

Further, feature of the present invention will become apparent to those skilled in the art to which the present invention relates from reading the following specification with reference to the accompanying drawings, in which:

FIG. 1 is a longitudinal cross sectional view showing the first embodiment of the spindle motor in accordance with the present invention;

FIG. 2 is a longitudinal cross sectional view showing the bearing means employed in the spindle motor of the first embodiment;

FIG. 3 is a longitudinal cross sectional view showing the second embodiment of the spindle motor in accordance with the present invention; and

FIG. 4 is a table showing the results obtained from the measurement on the variety of characteristics of the spindle motor in accordance with the present invention.

### DETAILED DESCRIPTION OF THE PRESENT INVENTION

The preferred embodiments of a spindle motor in accordance with the present invention will now be described.

### THE FIRST EMBODIMENT

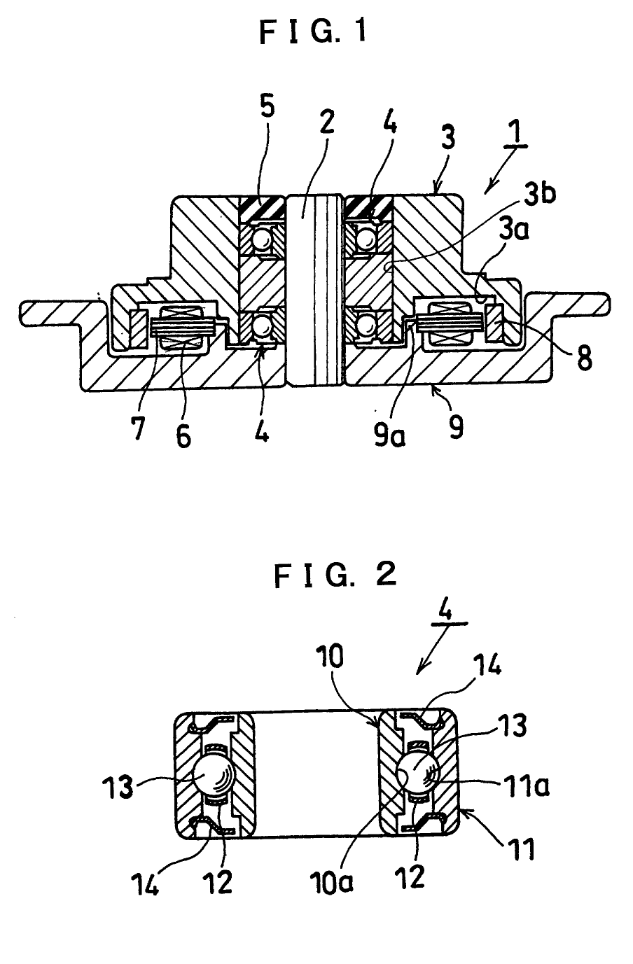

A spindle motor 1 of the first embodiment as shown in FIG. 1 includes a spindle shaft 2 secured to a base plate 9 to extending vertically therefrom, a rotor 3 of a sleeve like configuration, and a pair of upper and lower bearing means 4 interposed between the outer peripheral surface of the spindle shaft 2 and the inner peripheral surface of a vertically extending central through bore 3b of the rotor 3. Thus the rotor 3 can rotate in high speed around the spindle shaft 2.

Each of the bearing means 4 is a conventional ball bearing, and the spindle shaft 2 is a straight shaft.

A sealing member 5 of rubber for preventing dirt or dust from immigration into the bearing means 4 is provided above the upper bearing means 4 between the spindle shaft 2 and the rotor 3.

An annular recess 3a is provided on the lower surface of the rotor 3 to accommodate a stator 7 around which a coil 6 is wound. The stator 7 is supported by a protrusion 9a formed on the upper surface of the base plate.

A ring shaped magnet 8 is secured on the inner periphery of the recess 3a so as not to contact with the stator 7.

Upon supplying the alternative current from the control circuit (not shown) to the coil 6 to generate a magnetic field from the pole of the stator 7, the rotor 3 including the magnet 8 is rotated. The load from the rotation is to be supported by the spindle shaft 2 through the bearing means 4.

Each bearing means 4 includes an inner ring 10 having an inner raceway 10a on its outer peripheral surface, an outer ring 11 having an outer raceway 11a on its inner peripheral surface, and a plurality of rolling elements which are shown as balls 13 interposed between the inner raceway 10a and the outer raceway 11a and supported in their position by a retainer 12.

A pair of sealing plates 14 are provided on both side of the balls 13 to prevent the grease injected between the inner raceway 10a and the outer raceway 11a from splashing out.

The inner and outer rings 10, 11 of the bearing means 4 are made of high carbon chromium steel (SUJ 2 or the one similar to SUJ 2), and the hardness of each surface of the inner raceway 10a and the outer raceway 11a is made to HRC 62. The rolling elements shown as balls 13 are made of ceramic material such as silicon nitride, and the hardness of the surface thereof is made to HRC 75.

The structure of the retainer 12 and the sealing plates 14 are substantially the same as those employed in the prior art.

A comparison is made between the first embodiment in which balls of ceramic material are used and the prior art in which balls of high carbon chromium steel are used.

The comparison is made under the condition that the grease used in the bearing means of the spindle motor of the present invention and that used in the bearing means of the prior art are equal in their quality and quantity. The number of revolutions is set to 5400 rpm.

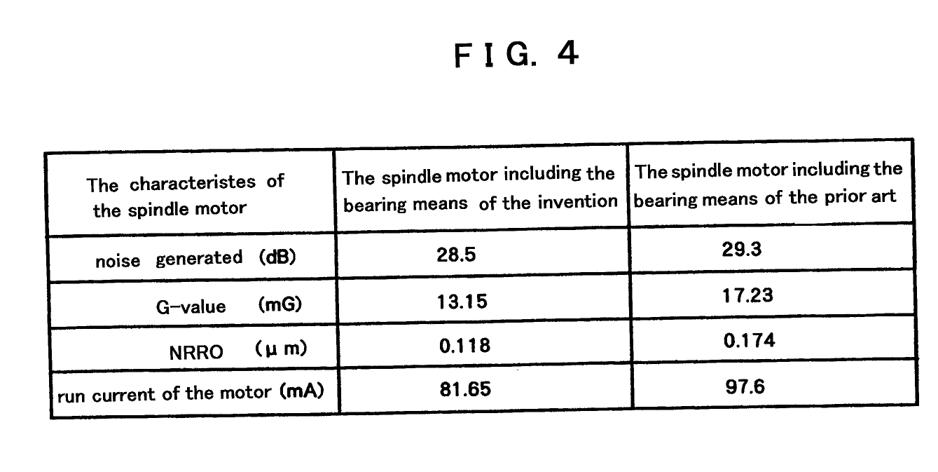

The measurement of the variety of characteristics of the spindle motor is made on the noise, the non-repetitive run out (NRRO) in the axial direction, the value of vibration level (G-value), and the run current of the motor. The results obtained therefrom are listed on FIG. 4.

As shown in FIG. 4, the characteristics of the spindle motor 1 of the present invention is that the noise is lower, the non-repetitive run out (NRRO) in axial direction, the G-value, the run current of the motor than those of the spindle motor in which incorporated the bearing means of the prior art the balls of which are of high carbon chromium steel.

As can be seen from above, the hard disk drive device including the spindle motor of the present invention shows increased densification, reduced electric energy consumption, and improved acoustic characteristics.

The centrifugal force F acting upon the rolling element when the spindle motor is operated in high rotational speed can be expressed by the following equation:

F=M(dp/2) (ωm)²

where the mass of the rolling element is M (kg), the pitch diameter of the rolling element is dp (m), the angular velocity (rad/s) of the rolling element around the axis of the spindle shaft is ωm.

The density of the high carbon chromium steel used in making the balls of the bearing means of the prior art incorporated into the spindle motor is about 7.8, whereas the density of the silicon nitride used in making the balls of the bearing means of the present invention incorporated into the spindle motor is about 3.2, i.e. less than half of the density of the high carbon chromium steel.

In this connection, the mass of the balls can be reduced to decrease the centrifugal force to be applied on the balls upon operated in high rotational speed. Thus the load to be applied due to the centrifugal force of the balls on the outer ring can also be reduced.

It is therefore possible to avoid the damage on the raceway of the outer ring. It is further possible to reduce the power consumption of the spindle motor since the inertia force is reduced by reducing the mass of balls.

The balls of ceramic material are improved in their wear resistance and heat resistance relative to those of prior art made of high carbon chromium steel, so that the seizure does not happen even on the initial lubrication. Further, the seizure does not happen even if the oil film formed between the contact area between the surface of the raceway and the rolling element is broken. Such breakage of the oil film is often caused by the reduction of the viscosity of the grease due to the heating of the ball bearing upon rotating in high speed.

Although in the bearing means 4 as shown in FIG. 2, sealing plates 14 are attached on both end of each bearing means, in the structure as shown in FIG. 1 in which the bearing means are incorporated into the spindle motor, it might of course be possible to provide the sealing plate 14 only on the side of each bearing means exposed to the outside thereof.

In such structure in which the sealing plate 14 is attached only on one side of the bearing, the inner sealing plates are unnecessary, and the number of components can be reduced, and the cost for manufacturing can also be reduced thereby.

### THE SECOND EMBODIMENT

The spindle motor of the second embodiment has a spindle shaft 16 of stepped structure in which a reduced diameter portion 16a and a larger diameter portion 16b are provided.

A bearing means 21 including the stepped shaft further comprises an outer ring 18 of cylindrical configuration disposed around the spindle shaft 16, and an inner ring 17 having an inner raceway 17a formed on its outer peripheral surface. The inner ring 17 is fit around the reduced diameter portion of the stepped shaft and secured thereto.

A pair of double row outer raceways 18a, 18b are formed on an inner peripheral surface of the outer ring 18. Balls 20 are interposed between the one outer raceway 18a and the inner raceway 17a, and retained in their position by a retainer 19.

Further, balls 23 are interposed between an inner raceway 16c formed around an outer peripheral surface of the larger diameter portion 16b of the spindle shaft and the other outer raceway 18b, and retained in their position by a retainer 22.

The outer periphery of the cylindrical outer ring 18 is fit integrally within the central through bore 3b of the rotor 3.

Other structural elements of the bearing means of the second embodiment which are essentially the same as those of the first embodiment are designated by the same reference numerals as those employed in the first embodiment, and the descriptions thereon are omitted.

In this embodiment, the spindle shaft 16, the inner and outer rings 17 and 18 of the bearing means are made of high carbon chromium steel (SUJ 2 or the one similar to SUJ 2), and the rolling elements or balls 20, 23 are made of ceramic material such as silicon nitride, and the hardness of the surface thereof is made to HRC 75.

Regarding the spindle motor 15 of such structure, a comparison and measurement is also made relative to the prior art in the same manner as mentioned above. The measured values of the noise, the non-repetitive run out in the axial direction, the G-value, and the run current of the motor are confirmed to be reduced as the results as obtained on FIG. 4.

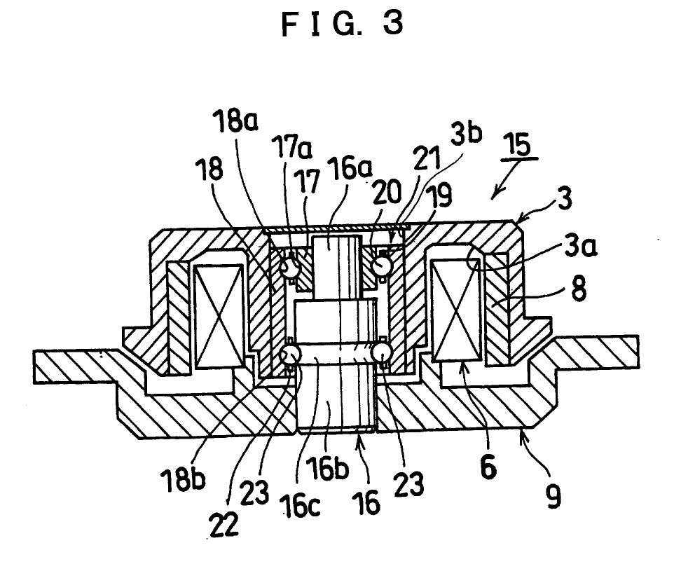

Although the bearing means 21 incorporated into the spindle motor as shown in FIG. 3 has the structure in which no sealing plates are provided, the structure in which the sealing plates are attached to prevent the injected grease from splashing out can also be adopted.

Although the silicon nitride material is used to form the balls in the above mentioned embodiments, the balls can also be made of the fine ceramics such as alumina, zirconia, silicon carbide, and so on.

Further, only balls are made of ceramic material, the inner and outer rings can also be made of ceramic material.

### The Effects of the Invention

The present invention is a spindle motor of the above described structure into which a bearing apparatus including inner and outer rings of steel and the rolling elements of ceramic material is incorporated. In this connection, the raceway surfaces of the inner and outer rings as well as the surfaces of the rolling elements are hard to be damaged, the centrifugal forces to be applied on the rolling elements do not increase even if the spindle motor is rotated in high speed, so that the load to be applied on the outer ring can also be limited, the acoustic characteristics (the level of the noise generated) and/or the vibration characteristics are improved, and the lifetime of bearing means can be elongated.

While particular embodiments of the present invention have been illustrated and described, it should be obvious to those skilled in the art that various changes and modifications can be made without departing from the spirit and scope of the invention.

What is claimed is:

1. A spindle motor comprising a spindle shaft, a rotor, and a bearing means interposed between the spindle shaft and the rotor, the bearing means including inner and outer rings and rolling elements interposed therebetween, wherein the inner and outer rings of the bearing means are made of steel, and the rolling elements are made of ceramic.

2. The spindle motor as claimed in claim 1 wherein the spindle shaft is a straight shaft, and the bearing means is the ball bearing.

3. The spindle motor as claimed in claim 1 wherein the spindle shaft is a stepped shaft including a larger diameter portion and a reduced diameter portion, the outer ring is a cylindrical one surrounding the stepped shaft, the inner ring has an inner raceway on its outer peripheral surface and is fit around the reduced diameter portion of the spindle shaft and secured thereto, the bearing means further includes rolling elements interposed between the inner raceway and an outer raceway formed on the inner periphery of the outer ring, and rolling elements interposed between an inner raceway formed directly on the larger diameter portion of the spindle shaft and another outer raceway formed on the inner periphery of the outer ring.
